(19) United States
(12) Patent Application Publication
(10) Pub. No.: US 2006/0147297 A1
(43) Pub. Date: Jul. 6, 2006

(54) Ergonomic pin and ergonomic pin clip

(76) Inventors: Ronald H. Wrase, Savage, MN (US); Bruce E. Kyro, Prior Lake, MN (US)

Correspondence Address: WALTER K. ROLOFF, 490 HARBOR COURT, SHOREVIEW, MN, 55126, US

(21) Appl. No.: 11/365,336

(22) Filed: Feb. 28, 2006

Related U.S. Application Data
(63) Continuation-in-part of application No. 10/940,189, filed on Sep. 13, 2004.

(51) Int. Cl. F16B 21/14

(52) U.S. Cl. 411/513

(57) ABSTRACT

An ergonomic pin and an ergonomic pin clip comprise, respectively, a pin body having an elongated portion and a grip portion, and a clip body having an engagement portion and a grip portion. The elongated portion of the pin engages and disengages a receiving member and is selectively decorative. The grip portion of the pin is selectively angled relative to its elongated portion, provides ergonomic gripping thereof by a user, and is selectively decorative. The engagement portion of the clip engages and disengages the pin. The grip portion of the clip is selectively angled relative to its engagement portion, provides a substantially handle-like structure, provides ergonomic gripping thereof by a user, and is selectively decorative.

### CROSS REFERENCE TO RELATED APPLICATION

The present application is a continuation-in-part of co-pending, non-provisional application Ser. No. 10/940,189 filed on Sep. 13, 2004, the entirety thereof being incorporated herein by reference thereto.

### FIELD OF THE INVENTION

The present invention relates generally to securing pins and pin clips. The invention relates specifically to an ergonomic pin and ergonomic pin clip for securing a receiving member such as a trailer hitch.

### BACKGROUND OF THE INVENTION

Pins and pin clips for securing receiving members are well known. Typically, in combination, they are simple mechanical devices, being constructed from only a few metal parts.

The pins, individually, are typically constructed from a hardened metal and are simply required to be durable and capable of withstanding heavy loads. Other pins are intended to shear under excessive loads, to prevent damage to associated components. Aside from physical dimension requirements, pins are for the most part very basic in design. Like the pins, the pin clips (or “pin retaining devices”) are also well known. So-called “quick connect/disconnect” or “hair pin” type securing pin clips, as well as “bridge pin clips” or “cotter pin clips” among others (collectively, also, “clips”) are typically utilized in combination with a pin which, together, prevent disengagement of a pin from a receiving member such as, for example, a trailer hitch assembly. In a particular use, the commonly metal and cylindrically wire-like pin clip is inserted into a hole of, or is otherwise forcibly engaged with, the pin to prevent the pin from being unintentionally disengaged from the receiving member. The pin clip prevents the pin from moving excessively due to forces that would tend to cause the pin to “back out” from the receiving member.

Those who have used such conventional pins and pin clips appreciate how difficult they may be to manipulate, particularly in cold temperatures or when one does not have full use of fingers or a hand due to wearing a glove or mitten. Those with physical disabilities, such as missing fingers or a lack of strength or dexterity, also experience significant difficulties in attempting to use known pins and clips. Often, hand injuries result from a loss of one's grip on the pin and/or clip, or from the pin finally releasing under force from the user, and consequent accidental forceful impact with a nearby assembly. Relatively small clip dimensions can painfully cut into a user's skin. Also, as too often experienced by sportsmen while attempting to hitch a trailer to a vehicle, known pins and clips are notoriously easy to lose when accidentally dropped into snow or water. Thus, the known pins and clips are often anything but quickly connected or disconnected, or easy to use. Often, in cold environments, a user must use bare hands to manipulate the pins and clips. Since a vast majority of pins and pin clips are fabricated from metal, substantial discomfort and even hypothermic injury can result from such manipulations.

Therefore, there exists a need for an ergonomic pin and ergonomic pin clip which each overcomes the drawbacks of the well known pins and pin clips. There also exists a need, generally, for an ergonomic pin and ergonomic pin clip which is easier to use, particularly for those with physical disabilities.

### SUMMARY OF THE INVENTION

An object of the present invention is to provide an ergonomic pin and ergonomic pin clip which are generally easy to use.

Another object of the present invention is to provide an ergonomic pin and clip which are specifically easy to use by those with disabilities or having problems with manual dexterity.

A further object of the present invention is to provide an ergonomic pin and clip which tend to prevent injuries, in use

A still further object of the present invention is to provide an ergonomic pin and clip which are easy to find after being accidentally dropped.

A yet further object of the present invention is to provide an ergonomic pin and clip which minimize discomfort when manipulated in cold environments.

In accordance with the present invention, an ergonomic pin and an ergonomic pin clip comprise, respectively, a pin body having an elongated portion and a grip portion, and a clip body having an engagement portion and a grip portion. The elongated portion of the pin engages and disengages a receiving member and is selectively decorative. The grip portion of the pin is selectively angled relative to its elongated portion, provides ergonomic gripping thereof by a user, and is selectively decorative. The engagement portion of the clip engages and disengages the pin. The grip portion of the clip is selectively angled relative to its engagement portion, provides a substantially handle-like structure, provides ergonomic gripping thereof by a user, and is selectively decorative.

### BRIEF DESCRIPTION OF THE DRAWINGS

FIG. 1 is a perspective illustration of a pin and clip of the prior art.

FIG. 2 is a perspective illustration of an exemplary ergonomic pin and clip, constructed in accordance with the present invention.

FIG. 2a is a profile illustration of the ergonomic clip of FIG. 2, taken along reference line 2a-2a.

FIG. 2b depicts an alternative embodiment of an ergonomic pin, constructed in accordance with the present invention.

FIG. 2c depicts an alternative embodiment of an ergonomic clip, constructed in accordance with the present invention.

FIG. 3 depicts another alternative embodiment of an ergonomic pin an ergonomic clip, constructed in accordance with the present invention.

FIG. 3a is a profile view of the ergonomic clip in FIG. 3 along line 3a-3a.

FIG. 4 depicts additional alternative embodiments of an ergonomic pin clip, constructed in accordance with the present invention.

FIG. 4a is a profile view of a first alternative embodiment of the ergonomic pin clip in FIG. 4 along line 4a-4a.

FIG. 4b is a profile view of a second alternative embodiment of the ergonomic pin clip in FIG. 4 along line 4b-4b.

FIG. 5 depicts yet another alternative embodiment of an ergonomic pin clip, constructed in accordance with the present invention.

FIG. 6 depicts an alternative component of an ergonomic pin clip of the present invention.

FIG. 7 depicts an alternative embodiment of an ergonomic pin, constructed in accordance with the present invention.

FIG. 8 depicts another alternative embodiment of an ergonomic pin, constructed in accordance with the present invention.

### DETAILED DESCRIPTION OF THE INVENTION

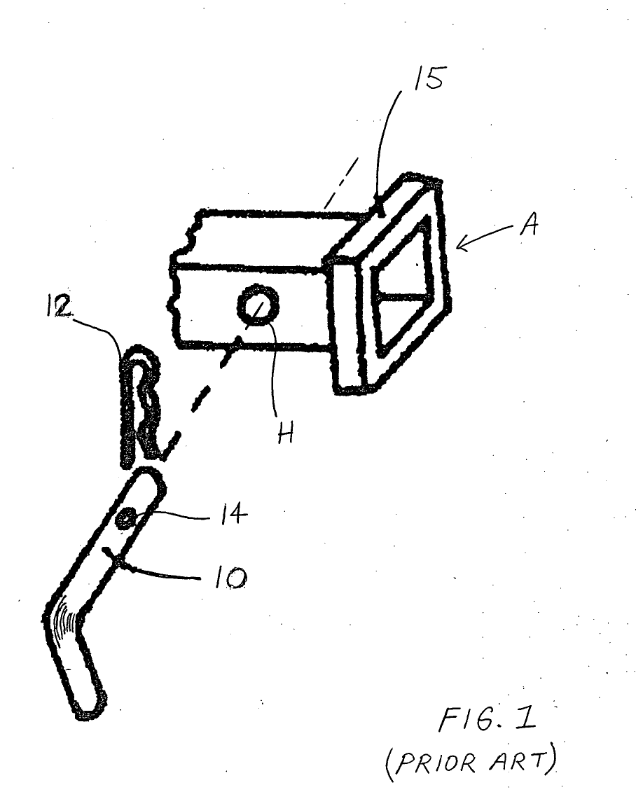

Referring to FIG. 1, a common prior art pin 10, pin clip 12, and receiving member (or “receiver”) 15 are shown as components of, by way of example, a typical trailer hitch. In well known use of these exemplary components, a trailer hitch or “ball assembly” (not shown) is slid into receiver 15 at receiver aperture A. The ball assembly includes a hole there throughout, which upon sliding the assembly into aperture A is aligned by a user with holes H on opposite sides of receiver 15, in concentric alignment with each other (only one hole H of receiver 15 is depicted in the figure, the other being hidden). With the hole throughout the ball assembly (again, not shown) in alignment with holes H of receiver 15, pin 10 is then slid into one hole H of receiver 15, then through the hole throughout the ball assembly, and finally through the opposite hole H of receiver 15; pin 10 thus protrudes from both sides of receiver 15 with the ball assembly being securely held in place thereby. Pin clip 12 is then inserted into hole 14 of pin 10 in conventional fashion, to prevent pin 10 from being unintentionally disengaged or “backing out” from receiver 15 and the ball assembly. A bend as shown in pin 10 is typically provided in pins of the prior art, to prevent them from passing fully through receiver 15 and the assembly; thus, due to the presence of clip 12 in hole 14 and the bend in pin 10, lateral movement of pin 10 is limited. So secured, as is well understood, pin 10 thus prevents unintentional disengagement of the ball assembly from receiver 15. Due to significant loads commonly imparted to the ball assembly and the aforedescribed components in use, and in particular pin 10, high-grade and high-strength metals such as hardened steel are commonly used for fabrication thereof. Although depicted as a bent cylindrical pin having hole 14 there throughout, pin 10 could of course take many forms such as a channeled or bored load-bearing member of virtually any useful dimensions, where clip 12 would engage the particular channel or bore.

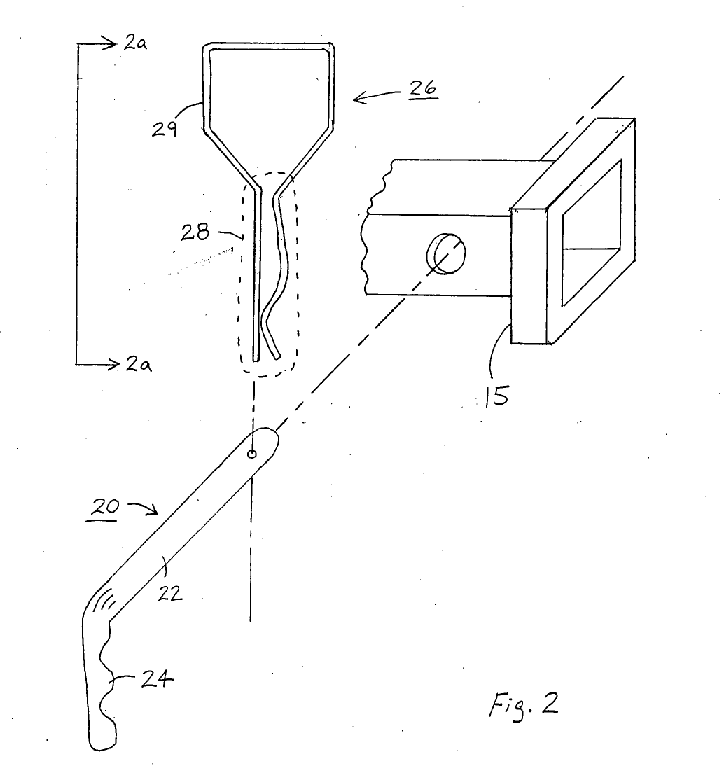

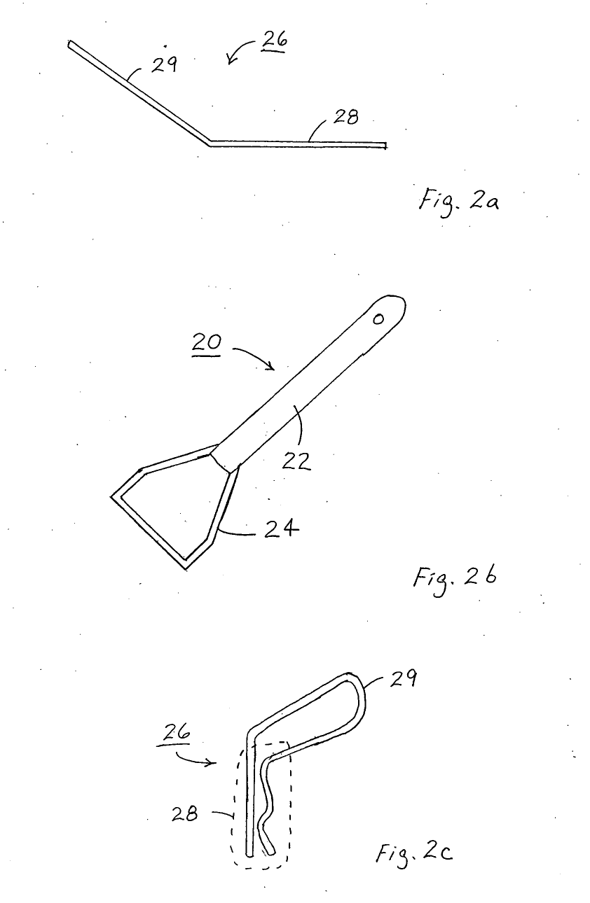

To overcome the drawbacks of the prior art pins and pin clips as described above, the present invention provides novel and heretofore unknown features in a pin and pin clip. Specifically, with reference to FIG. 2, an ergonomic pin 20 and ergonomic pin clip 26 of the present invention are depicted with a typical receiving member (receiver 15 of FIG. 1). Ergonomic pin 20 includes an elongated pin body 22 that is designed to engage and disengage receiver 15, and a grip portion 24. Grip portion 24 is designed to (i) be selectively angled relative to elongated pin body 22, and (ii) provide ergonomic gripping thereof by a user. In this regard, and with comparison to the prior art pin 10 of FIG. 1, it will be appreciated that grip portion 24 of ergonomic pin 20 is configured to adapt to a natural, typical conformation of fingers and/or a hand (“physique”) of a user, unlike the known pins. Specifically, grip portion 24 is configured to accommodate not just one but several fingers of a user's hand; also, portion 24 is preferably angled (although not required to be so) relative to pin body 22 to increase leverage thereon, particularly when forcibly removing pin 20 from receiver 15.

Although not illustrated, a suitable mechanical stop may be provided instead of the aforementioned bend in exemplary pin 20. Such a “mechanical stop” may be any member, coupled to pin 20 or integrally formed therein, that would serve to prevent pin 20 from passing through a receiver with which it is being utilized.

Again although not illustrated, all or a selected portion of grip portion 24 of ergonomic pin 20 may be a soft material, to further enhance ergonomics. The soft material, such as may be provided by a so-called PVC plastisol, a fluidized bed plastisol coating, a plastisol dip molding, or other compliant material, may also advantageously be an insulating material. An insulating material may be of particular benefit when utilizing the pin in cold temperatures. Furthermore, the soft material may also be itself a selected color or separately colored as such by paint, for example. The selected color could be of high-visibility, or be a trademarked or brand-identifiable color as may be desired in a particular use of the present invention. A high-visibility material may be of particular benefit when the pin would be subject to being accidentally dropped in water or snow. Of course, portion 24 could advantageously be any combination of soft, insulating, and selected color materials.

With continued reference to FIG. 2, ergonomic pin clip 26 includes a clip body 28 that is designed to engage and disengage pin 20, and a grip portion 29. Grip portion 29, analogously to grip portion 24 of pin 20, is designed to (i) be selectively angled relative to clip body 28, and (ii) provide ergonomic gripping thereof by a user. In this regard, and with comparison once again to the prior art clip 12 of FIG. 1, it will be appreciated that grip portion 29 of ergonomic clip 26 is configured to adapt to a natural, typical conformation of the physique of a user, unlike the known clips. Specifically, grip portion 29, like grip portion 24 of pin 20, could be configured to accommodate not just one but several fingers of a user's hand; also, portion 29 is preferably angled (although not required to be so) relative to body 28 as shown in FIG. 2a, to increase leverage thereon, particularly when forcibly removing clip 26 from pin 20. Such preferred angulation of portion 29 to body 28 also would increase a user's clearance from receiver 15, thereby minimizing any likelihood of painful impact therewith. Like grip portion 24 of pin 20, and again although not illustrated, all or a selected portion of grip portion 29 of clip 26 may be a soft or conforming, complimentarily shaped material, to further enhance ergonomics as aforedescribed relative to pin 20. The material may be any combination of soft, insulating, and selected color materials as aforedescribed.

With reference now to FIGS. 2b and 2c, depicted are alternative embodiments of pin 20 and clip 26, respectively. It is to be appreciated that such exemplary embodiments of the inventive, ergonomic concept of the present invention have heretofore not been known in the art. In FIGS. 2b-2c, it is to be understood that grip portions 24 and 29, respectively, may be angled relative to bodies 22 and 28, for enhanced ergonomic effects.

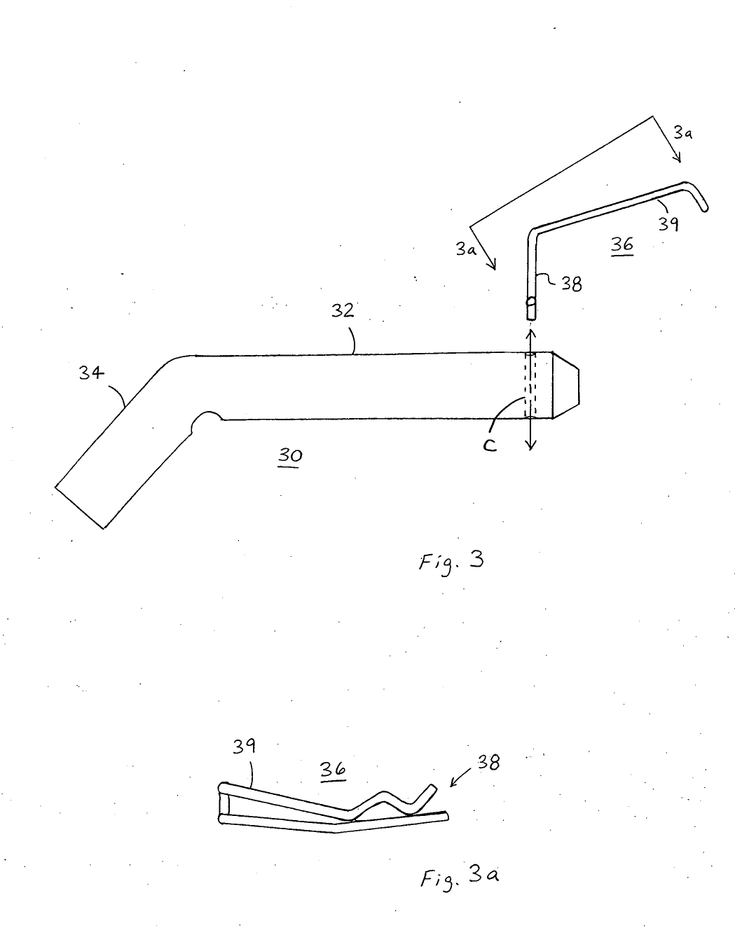

Turning now to FIG. 3, therein depicted is another alternative embodiment of an ergonomic pin 30, constructed in accordance with the present invention. Pin 30 comprises a pin body having an elongated portion 32 and a grip portion 34. Elongated portion 32 is designed to engage and disengage receiver 15, while grip portion 34 is designed to (i) be selectively angled relative to elongated portion 32, and (ii) provide ergonomic gripping thereof by a user. In this regard, and with comparison to the prior art pin 10 of FIG. 1, it will be appreciated that grip portion 34 of ergonomic pin 30 is configured to adapt to a natural, typical conformation of fingers and/or a hand (“physique”) of a user, unlike the known pins. As aforedescribed with respect to FIG. 2, grip portion 34 is configured to accommodate not just one but several fingers of a user's hand; and portion 34 is preferably angled (although not required to be so) relative to elongated portion 32 to increase leverage thereon, particularly when forcibly removing pin 30 from receiver 15.

Although not illustrated, a selected portion of grip portion 34 of ergonomic pin 30 may include a covering material. As used here throughout, the phrase “covering material” includes any suitable or desired material for covering a selected portion of grip portion 34, such as, for example, a soft material to further enhance ergonomics. The covering material may also be, for example, an insulating material, a colored material, a high-visibility material, and even a phosphorescent or “glow-in-the-dark” material. Of course, any combination of the foregoing attributes of a covering material, such as those aforedescribed relative to the discussion associated with FIG. 2, could be provided with each other as desired. It is also to be understood that a selected covering material may provide any advertising, aesthetically appealing, or otherwise desired appearance (collectively, as used here throughout, “decorative”) such as, for example, a rendition of a beverage bottle, a company logo, a slogan, a fish, an animal, a sport, or a hobby. Also, the covering material may be coupled to grip portion 34 by any technique that is suitable for use with the particular covering material itself, such as, for example: slip on, snap on, thread on, mold on, plastisol dip, or any suitable fastening or coupling means, either alone or in combination.

With continued reference to FIG. 3, and also FIG. 3a, ergonomic pin clip 36 includes a clip body having an engagement portion 38 and a grip portion 39. Engagement portion 38 of pin clip 36 is designed to engage and disengage pin 30 (or any pin, for that matter) to secure the pin in a receiving member and thereby prevent unintentional disengagement of the pin from the receiving member. Grip portion 39 of pin clip 36, analogously to grip portion 34 of pin 30, is designed to (i) be selectively angled relative to engagement portion 38, and (ii) provide ergonomic gripping thereof by a user. In this regard, and with comparison once again to the prior art clip 12 of FIG. 1, it will be appreciated that grip portion 39 of ergonomic pin clip 36 is configured to adapt to a natural, typical conformation of the physique of a user, unlike the known clips. Specifically, grip portion 39, like grip portion 34 of pin 30, may be advantageously configured as shown to accommodate not just one but several fingers of a user's hand; also, portion 39 is preferably angled (although not required to be so) relative to portion 38 to increase leverage thereon, particularly when forcibly removing pin clip 36 from a pin in which it is being used. Such preferred angulation of portion 39 to portion 38 would also increase a user's clearance from receiver 15, thereby minimizing any likelihood of painful impact therewith. Like grip portion 34 of pin 30, and although again not illustrated, a selected portion of grip portion 39 of pin clip 36 may include a covering material in any combination of attributes as aforedescribed. It is to be recognized by those of skill in the fastener arts that the covering material may itself provide enhancement of a retaining force in clip 36, by drawing together grip portion 39 and thereby increasing separation tension in engagement portion 38.

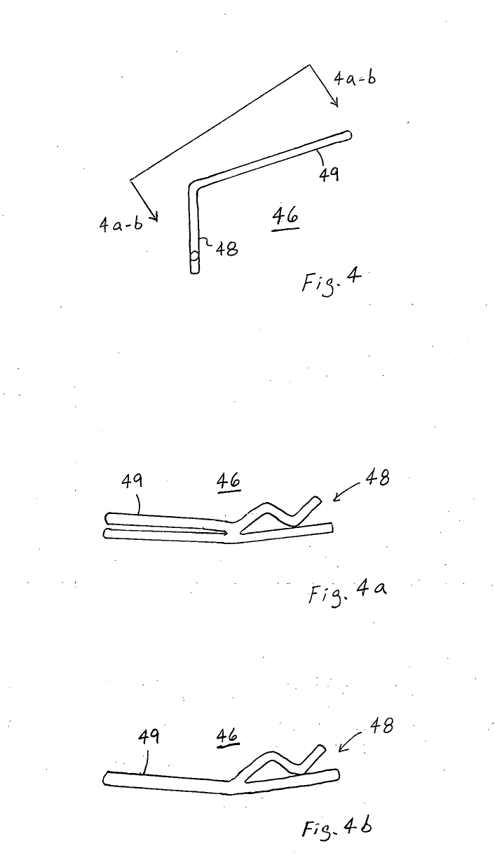

Turning, now, to FIGS. 4, 4a, and 4b, additional alternative embodiments of an ergonomic pin clip 46 of the present invention are depicted. In FIG. 4a, ergonomic pin clip 46 has a grip portion 49 constructed from two independent and generally cylindrical wire-like members. In FIG. 4b, however, ergonomic pin clip 46 has a grip portion 49 constructed from a single cylindrical wire-like member.

In FIG. 5, yet another alternative embodiment of an ergonomic pin clip 46 of the present invention is depicted. Therein, a conventional handle 50, which could be, for example, a simple wood dowel, has been added to grip portion 49. Also, like the aforedescribed covering material, handle 50 could of course be coupled to grip portion 49 by any technique that is suitable for use with a particular handle such as, for example: slip on, snap on, thread on, mold on, plastisol dip, or any suitable fastening or coupling means, either alone or in combination.

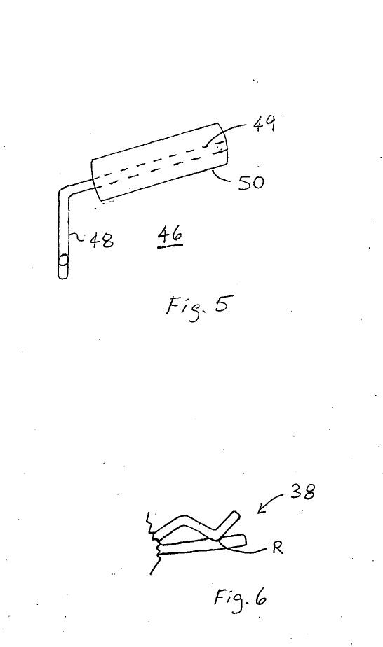

With attention now to FIG. 6, therein depicted is an alternative component of an ergonomic pin clip 36 of the present invention. Specifically, engagement portion 38 includes a recess R in one member thereof (the bottom one in the drawing) so that an “elbow” portion of the other member (the top one in the drawing) may rest therewithin, thereby increasing that component's retaining force in use, as known to those in the fastener arts.

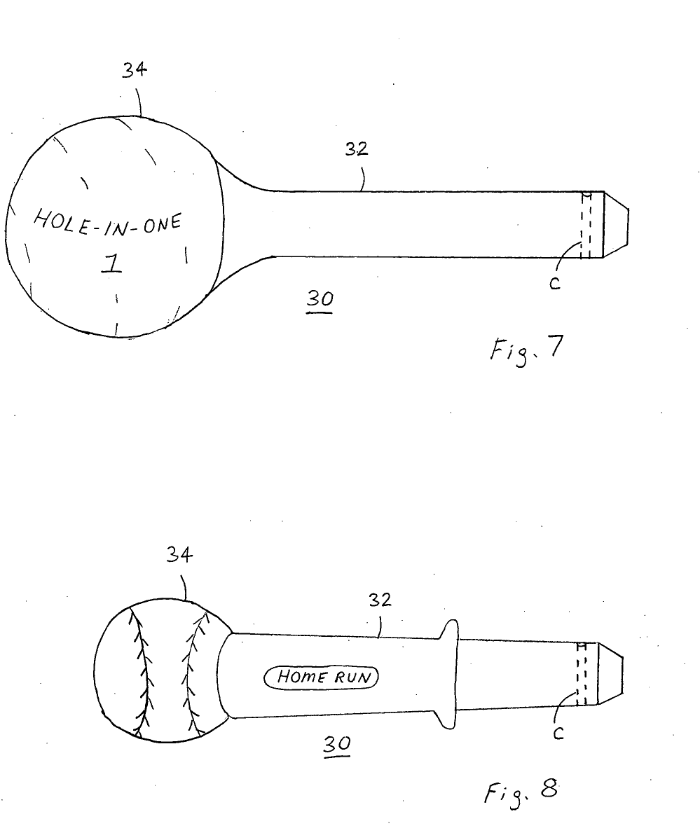

FIGS. 7 and 8 depict additional alternative novelty embodiments of an ergonomic pin 30, constructed in accordance with the present invention. In the figures, ergonomic pin 30 is shown as having novelty attributes that would appeal to golf and baseball enthusiasts, respectively. Aside from the appealing novelty designs of the golf tee for elongated portion 32 (in FIG. 7) and baseball bat for elongated portion 32 (in FIG. 8), it is to be particularly appreciated that the golf ball for grip portion 34 (in FIG. 7) and the baseball for grip portion 34 (in FIG. 8) serve as being both a decorative and an ergonomically comfortable gripping surface for a user. Regardless of any novelty attributes, it is to be observed that the grip portions of these exemplary embodiments effectively serve as a “suitable mechanical stop” as aforedescribed, thereby obviating any need for a bend in them.

Preferred materials for construction of the aforedescribed exemplary embodiments of the ergonomic pin and ergonomic pin clip of the present invention are carbon steel or stainless steel.

Regarding an angle that may be advantageously provided between the grip portions and bodies of the pins and pin clips of the present invention, approximately 45 degrees is preferred; but any angle may be utilized that is consistent with ergonomic considerations and effects.

Finally, some general observations are applicable to any embodiment of the ergonomic pin and ergonomic pin clip of the present invention. First, the engagement portion of the ergonomic pin clip is preferably designed and fabricated to have an adequate required pull-off force, or retaining force, when being removed from a pin. This may be achieved by any suitable means, such as for example by selective coupling of the grip portion of the clip to its engagement portion. In this regard, one or more techniques could be utilized (not illustrated) including one or more fractional or full (i) twists in the clip between its engagement and grip portions or (ii) cross-overs, offsets, or overlaps in the components of the engagement portion. These techniques could, furthermore, be provided alone or in any combination with each other. Also, the techniques could incorporate, either separately or together, the recess R as shown in FIG. 6. Second, it will be appreciated that the grip portion of the ergonomic pin clip is configured to provide a substantially handle-like structure, and provide ergonomic gripping thereof by a user. From the above exposition, such a handle-like structure is, preferably, a relatively tight loop of high-strength cylindrical steel (or high-strength steel wire). To avoid metal fatigue, loss of strength, and potential cracking and breaking, it should preferably not be bent to a radius that is smaller than the diameter of the component itself as known to those skilled in the fabricating arts. Furthermore, it will be appreciated that the handle-like structure that is characteristic of the grip portion of the ergonomic pin clip of the present invention overcomes drawbacks associated with relatively large loops of prior art clips wherein a user in effect exerts force against only a single wire of the loop. As shown analogously in FIGS. 7 and 8 with respect to an ergonomic pin, an ergonomic pin clip of the present invention could include any knob or “grab” portion as a handle-like structure disclosed herein. It is to be appreciated that the aforedescribed handle-like structure is intended to include any such structure that may be characterized as including at least one attribute of a handle, regardless of its size, shape, or geometric parameters. Finally, with respect to both the ergonomic pin and pin clip of the present invention, any decorative appearance as aforesaid could be incorporated into the structures, most readily at their grip portions but virtually anywhere. These could be, for example and as aforesaid, a rendition of a beverage bottle, a company logo, a slogan, a fish, an animal, a sport, or a hobby.

It is to be appreciated that although shown in the drawings and described in some instances as a combination, the ergonomic pin and ergonomic pin clip of the present invention may be advantageously utilized separately, with corresponding prior art clips and pins, respectively.

It is to be particularly appreciated that the pins and pin clips of the present invention may be advantageously used by those having physical disabilities, such as missing fingers, limited use of fingers or hands, or a lack of manual dexterity.

It is to also to be appreciated that although the ergonomic pin and ergonomic pin clip, either alone or in combination, have been described with reference to use in securing a receiving member such as a trailer hitch, they may each be used in any application where a pin or clip is desired such as in joining or securing various structural components of a particular apparatus or assembly.

It is to be further appreciated that any method of joining the respective components of the ergonomic pin and ergonomic pin clip of the present invention, such as for example slip on, snap on, thread on, mold on, or any suitable fastening or coupling means, either alone or in combination, may be utilized in provision thereof.

While the present invention has been particularly shown and described with reference to the accompanying figures, it will be understood, however, that other modifications thereto are of course possible, all of which are intended to be within the true spirit and scope of the present invention. It should be appreciated that components of the invention aforedescribed may be substituted for other suitable components for achieving desired results, or that various accessories may be added thereto.

Lastly, the choice, of course, of compositions, sizes, and strengths of various aforementioned components of the present invention are all a matter of design choice depending upon intended uses thereof.

Accordingly, these and other various changes or modifications in form and detail of the present invention may also be made therein, again without departing from the true spirit and scope of the invention as defined by the appended claims.

We claim:

1. An ergonomic pin for securing a receiving member, said ergonomic pin comprising:
a pin body having (i) at least one elongated portion and (ii) at least one grip portion,
wherein (i) said at least one elongated portion is configured to (a) selectively engage and disengage the receiving member as desired by a user, and (b) be selectively decorative, and (ii) said at least one grip portion is configured to (a) be at a selected angle relative to said elongated portion, (b) provide ergonomic gripping thereof by a user, and (c) be selectively decorative.

2. The ergonomic pin of claim 1, wherein said at least one grip portion of said pin body is configured to adapt to a natural, typical conformation of a physique of a user.

3. The ergonomic pin of claim 1, further comprising a covering material provided over a selected portion of said at least one grip portion.

4. The ergonomic pin of claim 2, further comprising a covering material provided over a selected portion of said at least one grip portion.

5. The ergonomic pin of claim 3, wherein said covering material is selected from the group consisting of a soft material, an insulating material, a colored material, a high-visibility material, and a glow-in-the-dark material.

6. The ergonomic pin of claim 4, wherein said covering material is selected from the group consisting of a soft material, an insulating material, a colored material, a high-visibility material, and a glow-in-the-dark material.

7. The ergonomic pin of claim 1, further comprising a mechanical stop in said pin body.

8. The ergonomic pin of claim 2, further comprising a mechanical stop in said pin body.

9. The ergonomic pin of claim 3, further comprising a mechanical stop in said pin body.

10. The ergonomic pin of claim 4, further comprising a mechanical stop in said pin body.

11. The ergonomic pin of claim 5, further comprising a mechanical stop in said pin body.

12. The ergonomic pin of claim 6, further comprising a mechanical stop in said pin body.

13. An ergonomic pin clip, for securing a pin in a receiving member to prevent unintentional disengagement of the pin from the receiving member, said ergonomic pin clip comprising:
a clip body, said clip body having (i) an engagement portion and (ii) a grip portion opposite said engagement portion; and
means for coupling said grip portion to said engagement portion, such that said coupling provides a selectively high retaining force capability in said engagement portion relative to the pin,
wherein (i) said engagement portion is configured to engage and disengage the pin as desired by a user, and (ii) said grip portion is configured to (a) be selectively angled relative to said engagement portion, (b) provide a substantially handle-like structure, (c) provide ergonomic gripping thereof by a user, and (d) be selectively decorative.

14. The ergonomic pin clip of claim 13, wherein said grip portion of said clip body is configured to adapt to a natural, typical conformation of a physique of a user.

15. The ergonomic pin clip of claim 13, further comprising a covering material provided over a selected portion of said at least one grip portion.

16. The ergonomic pin clip of claim 14, further comprising a covering material provided over a selected portion of said at least one grip portion.

17. The ergonomic pin clip of claim 15, wherein said covering material is selected from the group consisting of a soft material, an insulating material, a colored material, a high-visibility material, and a glow-in-the-dark material.

18. The ergonomic pin clip of claim 16, wherein said covering material is selected from the group consisting of a soft material, an insulating material, a colored material, a high-visibility material, and a glow-in-the-dark material.

19. In combination, an ergonomic pin and an ergonomic pin clip for securing a receiving member, said combination of said ergonomic pin and ergonomic pin clip comprising:
(I) an ergonomic pin including a pin body having (i) at least one elongated portion and (ii) at least one grip portion, wherein said at least one elongated portion is configured to (a) selectively engage and disengage the receiving member as desired by a user, and (b) be selectively decorative, and said at least one grip portion is configured to (a) be at a selected angle relative to said elongated portion, (b) provide ergonomic gripping thereof by a user, and (c) be selectively decorative; and
(II) an ergonomic pin clip, for securing said ergonomic pin in a receiving member to prevent unintentional disengagement of said pin from the receiving member, including (a) a clip body having (i) an engagement portion and (ii) a grip portion opposite said engagement portion, and (b) means for coupling said grip portion to said engagement portion, such that said coupling provides a selectively high retaining force capability in said engagement portion relative to the pin, wherein (a) said engagement portion is configured to engage and disengage the pin as desired by a user, and (b) said grip portion is configured to (i) be selectively angled relative to said engagement portion, (ii) provide a substantially handle-like structure, (iii) provide ergonomic gripping thereof by a user, and (iv) be selectively decorative.

20. The ergonomic pin of claim 19, wherein said grip portion of said pin body is configured to adapt to a natural, typical conformation of a physique of a user.

21. The ergonomic pin of claim 19, further comprising a covering material provided over a selected portion of said at least one grip portion.

22. The ergonomic pin of claim 20, further comprising a covering material provided over a selected portion of said at least one grip portion.

23. The ergonomic pin of claim 21, wherein said covering material is selected from the group consisting of a soft material, an insulating material, a colored material, a high-visibility material, and a glow-in-the-dark material.

24. The ergonomic pin of claim 22, wherein said covering material is selected from the group consisting of a soft material, an insulating material, a colored material, a high-visibility material, and a glow-in-the-dark material.

25. The ergonomic pin of claim 19, further comprising a mechanical stop in said pin body.

26. The ergonomic pin of claim 20, further comprising a mechanical stop in said pin body.

27. The ergonomic pin of claim 21, further comprising a mechanical stop in said pin body.

28. The ergonomic pin of claim 22, further comprising a mechanical stop in said pin body.

29. The ergonomic pin of claim 23, further comprising a mechanical stop in said pin body.

30. The ergonomic pin of claim 24, further comprising a mechanical stop in said pin body.

31. The ergonomic pin clip of claim 19, wherein said grip portion of said clip body is configured to adapt to a natural, typical conformation of a physique of a user.

32. The ergonomic pin clip of claim 19, further comprising a covering material provided over a selected portion of said at least one grip portion.

33. The ergonomic pin clip of claim 31, further comprising a covering material provided over a selected portion of said at least one grip portion.

34. The ergonomic pin clip of claim 32, wherein said covering material is selected from the group consisting of a soft material, an insulating material, a colored material, a high-visibility material, and a glow-in-the-dark material.

35. The ergonomic pin clip of claim 33, wherein said covering material is selected from the group consisting of a soft material, an insulating material, a colored material, a high-visibility material, and a glow-in-the-dark material.
